(19) United States
(12) Patent Application Publication
(10) Pub. No.: US 2014/0324422 A1
(43) Pub. Date: Oct. 30, 2014

(54) SYNCHRONOUS AUDIO DISTRIBUTION TO PORTABLE COMPUTING DEVICES

(71) Applicant: WTF Technology Partners, Inc., Lakewood Ranch, FL (US)

(72) Inventors: Wesley A. Winarski, Lakewood Ranch, FL (US); Andrew M. Traenkner, Lakewood Ranch, FL (US)

(73) Assignee: WTF Technology Partners, Inc., Lakewood Ranch, FL (US)

(21) Appl. No.: 14/256,644

(22) Filed: Apr. 18, 2014

Related U.S. Application Data
(60) Provisional application No. 61/813,462, filed on Apr. 18, 2013.

(51) Int. Cl. H04H 20/71; H04R 25/00; G10L 15/26

(52) U.S. Cl. CPC H04H 20/71; G10L 15/26; H04R 25/554
USPC 704/235; 381/2; 381/23.1

(57) ABSTRACT

Analog audio inputs are processed by a digital signal processor and rebroadcast over a local wireless network synchronous with a separate broadcast device or in real time with a live audio source. A software application on a portable computing device provides end-users the option to select from a plurality of audio source streams, cached translations of preprocessed audio streams and speech-to-text captioning. An embodiment of the invention relays wirelessly received digital audio streams converted from an analog source to the portable computing device then onto a hearing aid.

### BACKGROUND OF THE INVENTION

This invention relates to the distribution of audio and related data. More specifically, it relates to transmitting audio and/or text synchronous with a television, movie or live event to a portable computing device.

However, in view of the art considered as a whole at the time the present invention was made, it was not obvious to those of ordinary skill in the field of this invention how the shortcomings of the prior art could be overcome.

### SUMMARY OF THE INVENTION

The present invention relates to transmitting multiple analog audio streams wirelessly to a portable computing device (such as a smart phone or tablet). In one embodiment of the invention, a health club has eight (8) television sets positioned in front of stationary exercise equipment such as treadmills, elliptical machines and stationary bicycles. Each television set is tuned to a different channel. The health club cannot broadcast audio for the eight television sets simultaneously over external speakers so each piece of stationary exercise equipment is affixed with an RCA input and channel selector so the user can plug in their own headset and select one of the eight channels.

One drawback of this method is the expense of providing the audio channel selector at each piece of exercise equipment. Another drawback of this method is that there is no feedback as to the channel preferences of the user. Yet another drawback is there is no option to push context-based communications to the user based on the channel selection. These and other drawbacks prompted the present invention which captures a plurality of analog audio streams, converts them into a digital audio stream, and wirelessly transmits them to an application operable on a portable computing device.

In an embodiment of the invention, a low-cost single-board computer such as those sold under the brand RASPBERRY PI may act both as a digital signal processor (DSP) for converting analog audio into a digital audio stream as well as streaming the media itself. In the current iteration of the RASPBERRY PI device audio in is achieved through any supported USB input such as those sold under the brand SYBA model SD-AUD20066 which includes both an audio input and audio output. Accordingly, linking a RASPBERRY PI's USB connection to a USB hub provides the ability to bring in the eight audio input streams in our example above. The Model B of the RASPBERRY PI includes 10/100 wired Ethernet which can be linked to any readily available WiFi access point.

As the RASPBERRY PI runs on a lightweight LINUX distribution providing a server-based administration portal via HTTP is relatively straightforward. An administrator would set eight channel identities associated with each analog audio input that is received by the RASPBERRY PI device through the USB microphones. An audio streaming application such as ICECAST for LINUX can be deployed to stream multiple channels of audio simultaneously. An end user running a WiFi-capable portable computing device would find the WiFi access point and connect. By opening a browser the WiFi access point would direct the user to either a web-based audio client interface compatible with the user device's browser. By detecting the device settings in the host header of the browser for the device, a cascading style sheet (CSS) optimized for the device resolution and capabilities is applied. An embodiment of the invention captures the SSID of the WiFi access point and passes it to a web-server as a query string. This permits the web server to directly associate the access point with the connecting user and deliver location-based content directly to the user.

In addition to a web-based client, the present invention contemplates the ability to install a local application on the end user's portable computing device. Again, connecting to the WiFi access point would redirect the user to a landing page that initially restricts web browsing by using its own DNS servers until the end user has agreed to the terms of use and is set up to receive the audio streams. An advantage for the user is that once the local application is installed or at least the user has clicked through the initial agreement, he or she may have relatively unrestricted WiFi access to connect to websites, check emails and the like. For the health club, an advantage of the WiFi access point includes the ability to filter inappropriate websites that may be viewable to other patrons. The filtering may be achieved through DNS services such as those provided under the brand OPENDNS.

Another feature of the present invention relates to provided targeted content to the end user based on a number of factors including audio channel preferences. For example, if the user tends to listen to news related content versus daytime dramas. Content most relevant may be delivered to the user through the web-based media player client using an iframe or asynchronous JavaScript (AJAX). Alternatively, for local client applications, a developer would have even more options to deliver content.

Yet another feature includes audio-interrupt wherein the health club (or any other establishment transmitting multiple audio streams) may insert or overlay scheduled or ad hoc announcements. The announcements may relate to customer incentives, safety issues or the like.

Translation Synchronization

In an alternative embodiment of the invention a translation engine processes video on demand audio into text translations. The translations may be foreign language translations or cultural sensitivity translations which filter certain expressions or words.

### BRIEF DESCRIPTION OF THE DRAWINGS

For a fuller understanding of the invention, reference should be made to the following detailed description, taken in connection with the accompanying drawings, in which:

FIG. 1 is a diagrammatic view of a prior art audio distribution configuration.

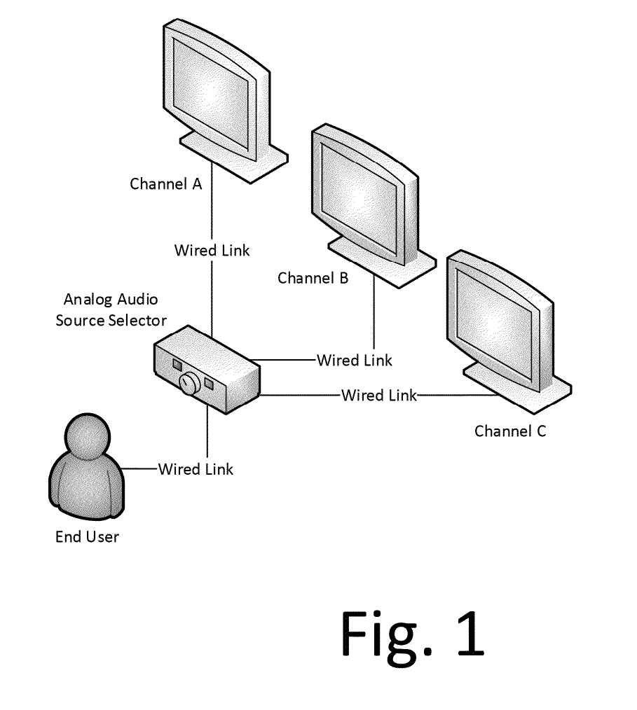

FIG. 2 is a diagrammatic view of an embodiment of the presentation invention distributing analog output from three sources via a dedicated wireless connection.

FIG. 3 is a diagrammatic view of an alternative embodiment of the presentation invention distributing analog output from three sources via a non-dedicated wireless connection.

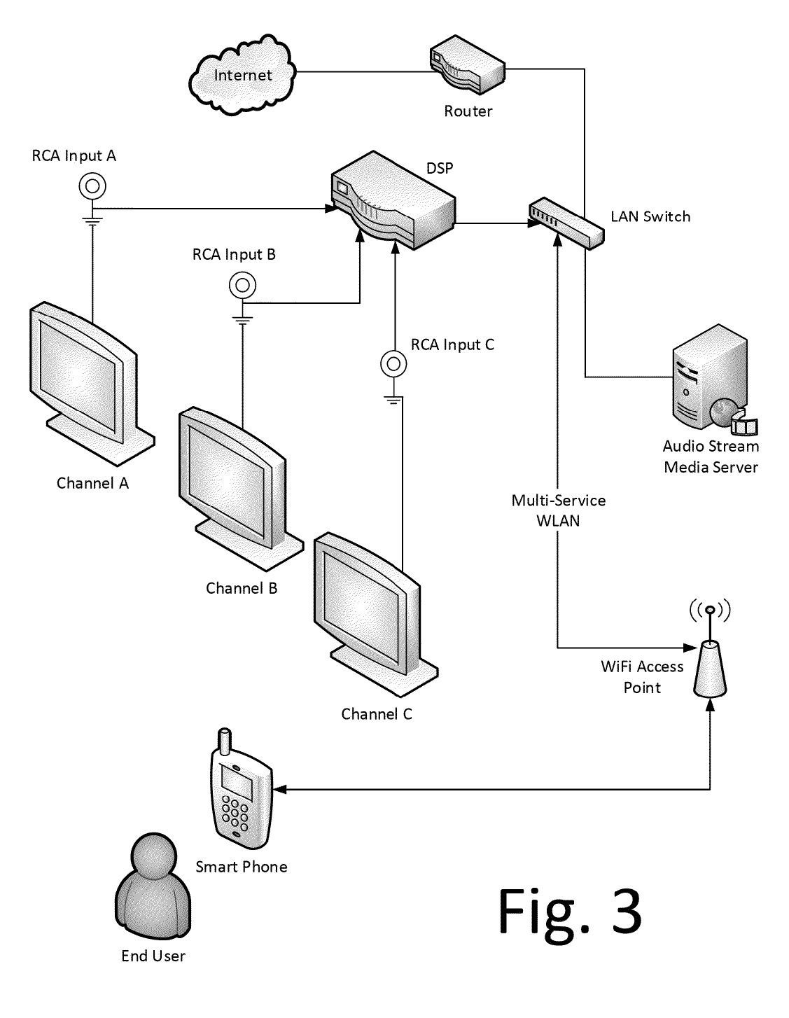

FIG. 4 is an exemplary GUI login dialog box.

FIG. 5 is an exemplary GUI access point dialog box.

FIG. 6 is a diagrammatic view of an embodiment of the invention that utilizes WiFi SSID strings as a primary key to retrieve remote data.

FIG. 6B is an exemplary GUI dialog box for administering a local audio distribution site with associated targeted advertising.

FIG. 7 is an exemplary GUI dialog box showing targeted advertising to an end user based on audio channel selection.

FIG. 8 is a diagrammatic view of an embodiment of the invention that translates archived audio into different and delivers them in synchronization with an independently initiated broadcast.

FIG. 9 is an exemplary GUI dialog box showing an end-user's interface for simultaneously receiving translated captioning and audio of a movie.

FIG. 10 is a diagrammatic view of an embodiment of the invention capturing a live audio input and wirelessly streaming both audio and text to a portable computing device which in turn streams the audio to a hearing aid.

FIG. 11 is a partially elevated view of a low cost computing device capable of enabling various embodiments of the invention.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments having structural changes may be made without departing from the scope of the invention.

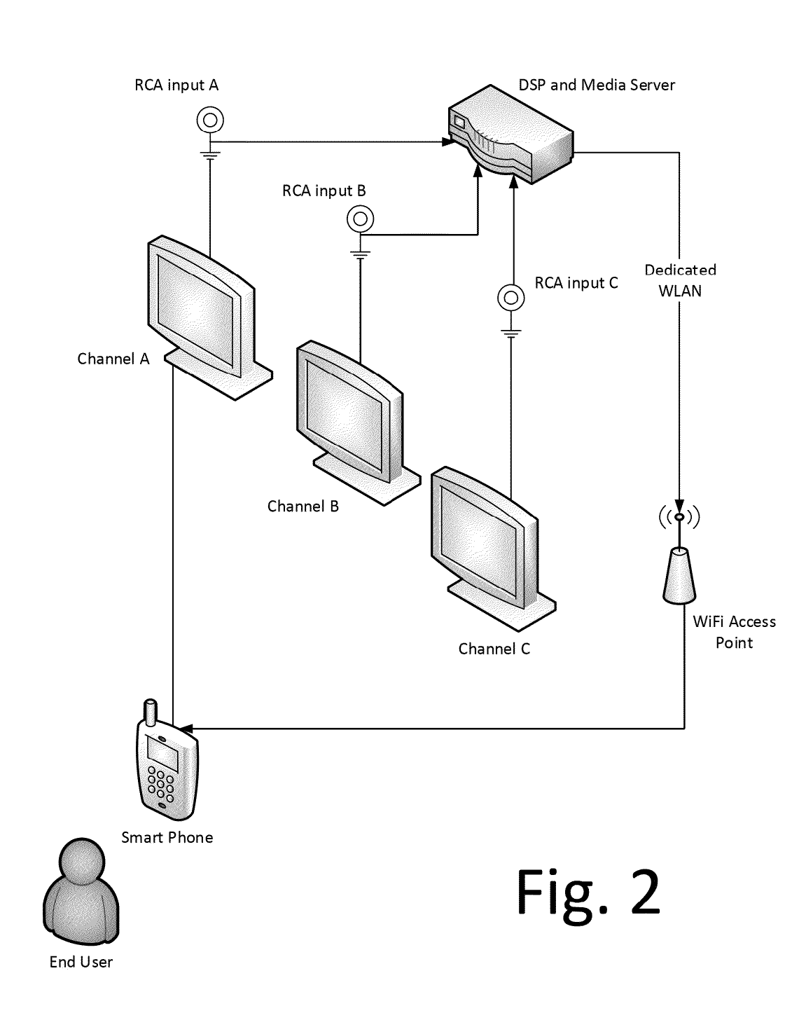

Referring to FIG. 2, one embodiment of the invention involves a plurality of television sets, whose audio outputs are connected to a digital signal processor (DSP). The DSP is connected to a CPU containing a set of instructions for converting the received analog audio signal to a digital audio stream. The CPU is connected to a wireless local area network (WLAN), which has a WiFi access point.

One example involves RCA television outputs being connected into a Behringer U-Control UCA202 DSP unit, which in turn is connected to a RASPBERRY PI (RP) via USB. The RP runs the Archlinux OS and a version of Advanced Linux Sound Architecture (ALSA), which is a lightweight, low latency audio package, along with Pulseaudio, which is a software SDK giving the RP network transmission capability via Real Time Transport Protocol (RTP). The RP is then plugged into a WiFi router, giving wireless transmission.

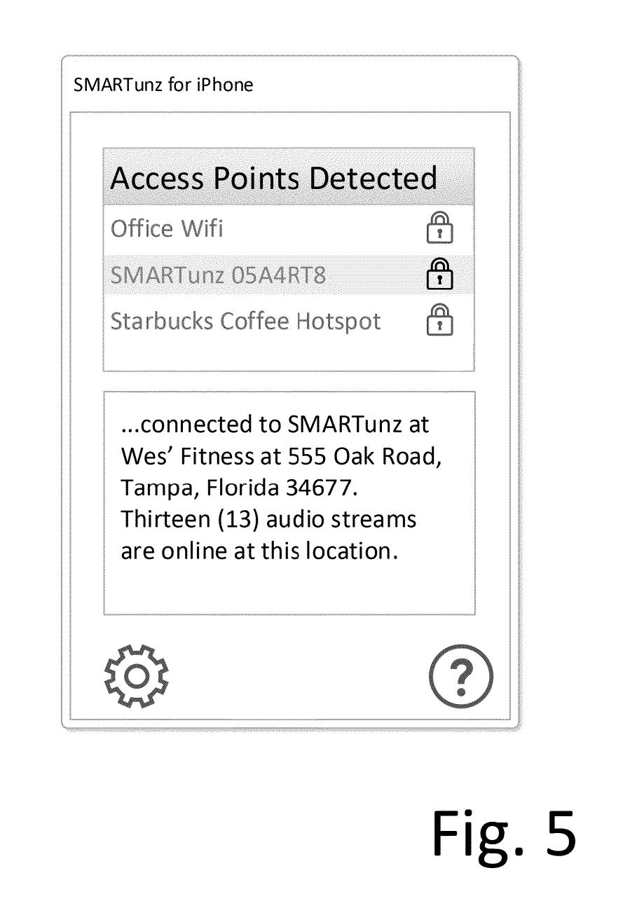

A portable WiFi-capable computing device, such as a smartphone or tablet, detects the WiFi access point as illustrated in FIG. 5. In the most basic embodiment, after the portable computing device is connected to the network, the list identifying all televisions is presented to the user on the screen of the device. The user selects the television for which he wishes to receive the audio feed, which is then streamed to the portable computing device via WLAN.

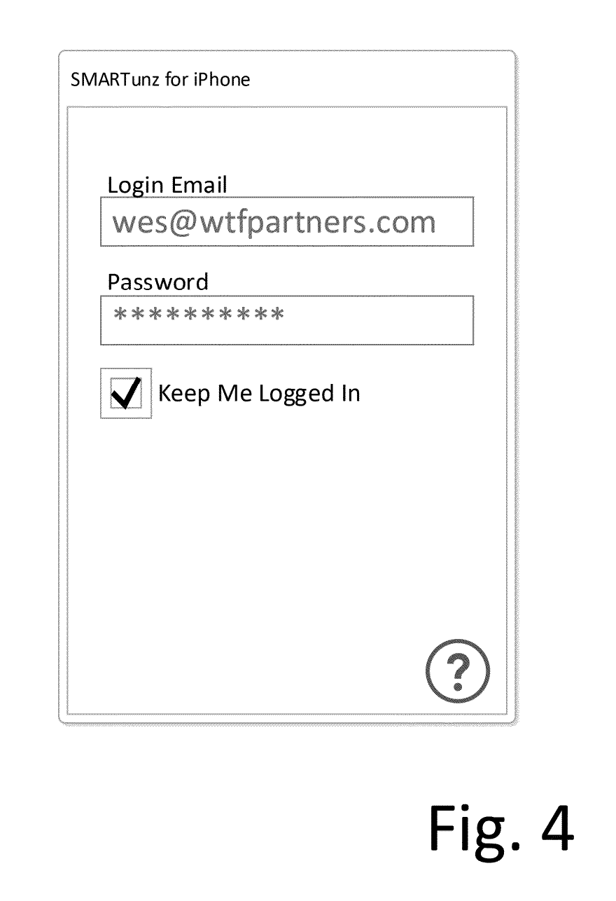

In an embodiment, the user may be required to enter login information, including an email address, as shown in FIG. 4, to gain access to the network. This may allow the system to track various aspects of the user's activity, such as days, times, duration, and frequency of using the service, user's television programming preferences, etc. Based on this information, the user may be provided with a wide array of individualized content and advertising. For example, if the system is being used in a fitness club, the system may be programmed to send an email message to a user after a few days of inactivity with encouraging content aimed at motivating the user to resume regular exercise schedule, which would likely increase the customer retention rate.

In one embodiment, the system uses a web-based audio client interface compatible with the user device's browser. By detecting the device settings in the host header of the browser for the device, a cascading style sheet (CSS) optimized for the device resolution and capabilities is applied.

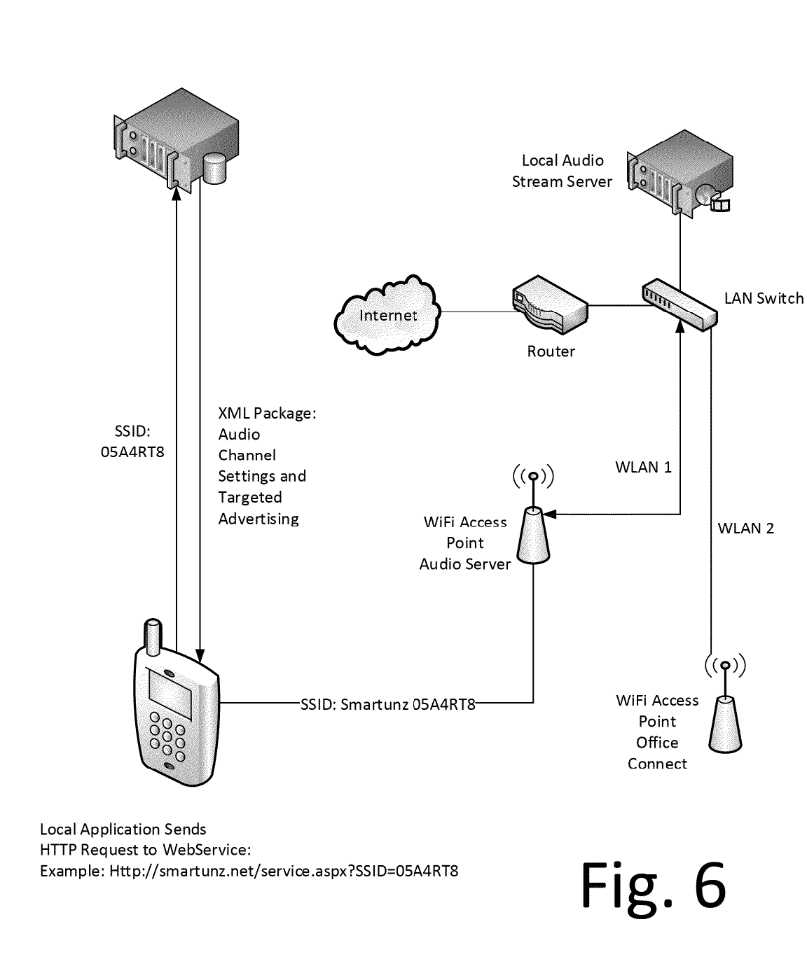

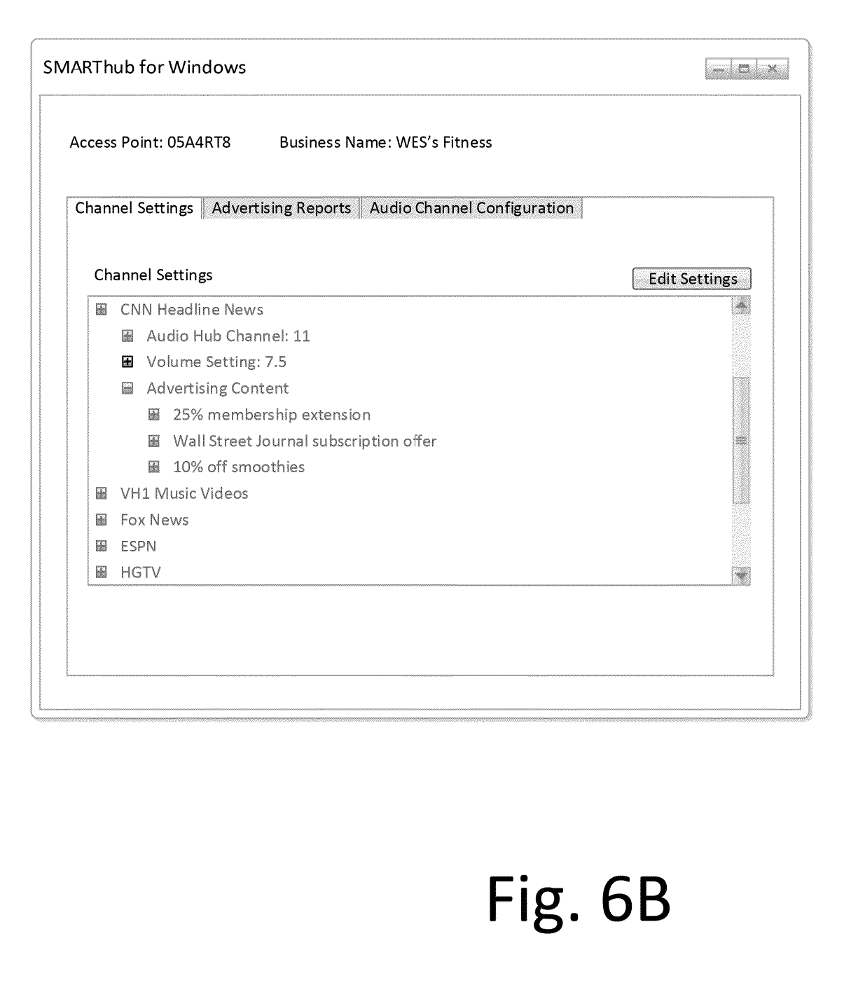

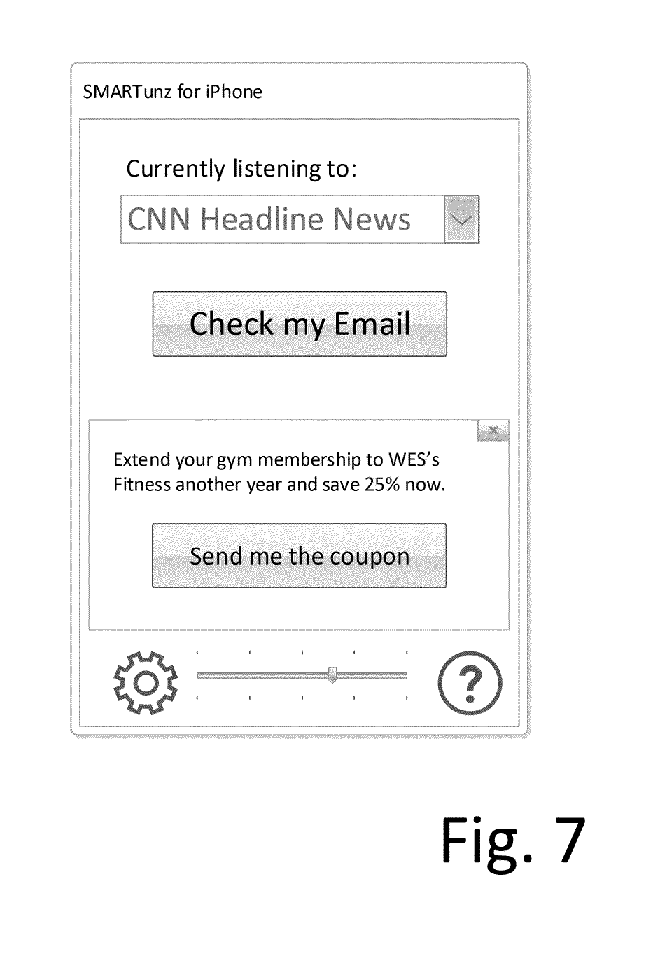

In an alternative embodiment, the system relies on a software program or a mobile app that a user installs on his portable computing device, as depicted in FIGS. 6B and 7. FIG. 6B is an exemplary GUI dialog box for a computing device running WINDOWS operating system. The dialog box illustrates some options and content that may be presented to the user including targeted advertising, television channel settings, and audio configuration preferences. These items are merely exemplary, and the GUI dialog box may have numerous additional settings without departing from the scope of the invention. FIG. 7 depicts and exemplary GUI dialog box for a tablet or a smartphone. The dialog box may include a wide array of functional and informational elements including the television programming selection, audio settings, and targeted advertising.

One important embodiment of the invention is depicted in FIGS. 6 and 6B. According to this embodiment, a portable computing device contains a set of instructions for identifying an SSID of the WiFi access point to which the computing device is connected. The computing device sends the SSID to a web server, which then identifies the facility corresponding to that SSID—for example, WES's Fitness—and transmits only content pertinent to that facility to the computing device. This allows for delivery of content tailored to patrons of that particular facility including targeted advertising, live audio stream for the local television channels, etc. This feature creates excellent opportunities for effective targeted advertising because the audience may be precisely identified. For example, if the SSID corresponds to a fitness club, the patrons may be interested in athletic clothing, dietary supplements, local restaurant providing healthy food, etc. On the other hand, if the SSID corresponds to a car dealership, advertising about automobiles and automobile-related products may be especially effective.

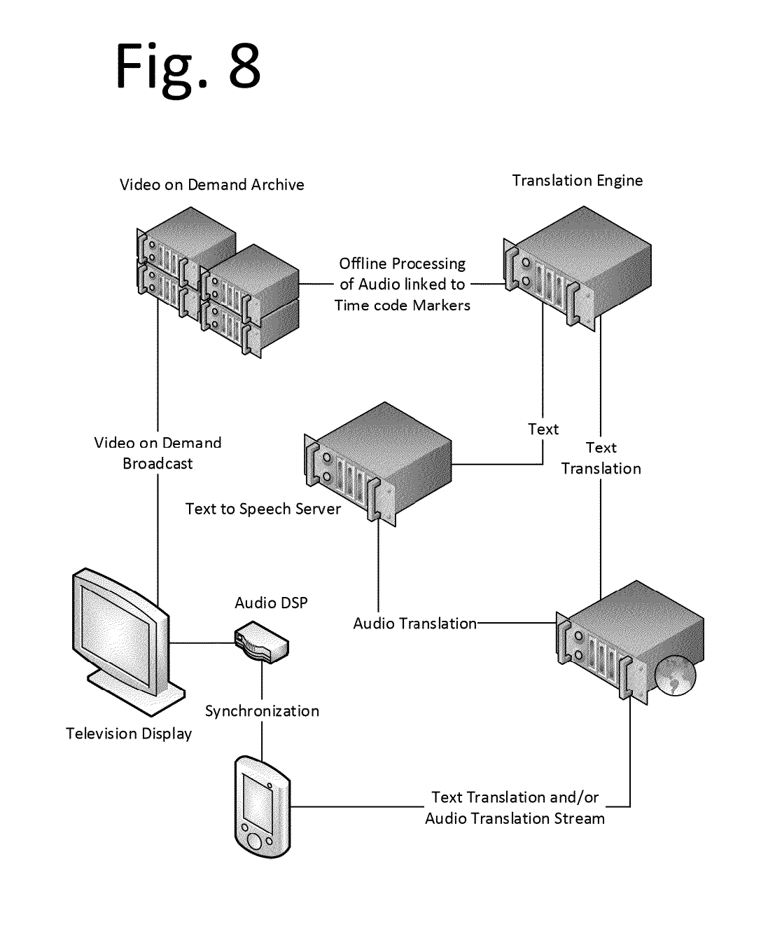

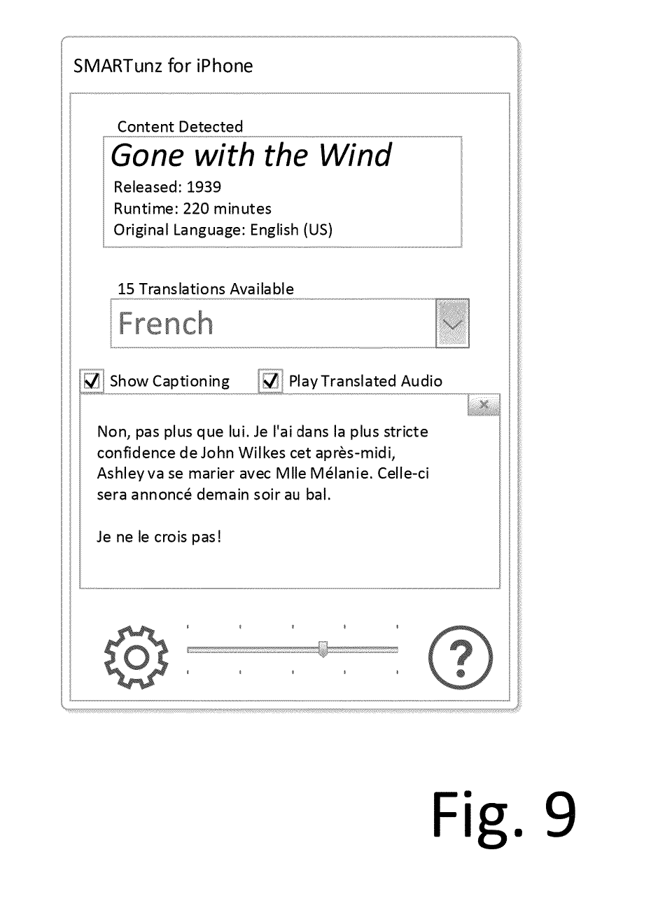

The system may also be used to provide users with an ability to receive audio stream and subtitles in a language the users prefer. This aspect of the invention is illustrated in FIG. 8. In one embodiment, time-coded captioning in the original language is stored in an archive. A translation engine server converts the time-coded captioning from the original language to a language specified by the user. The translated text may be converted to audio stream by a text to speech server preserving original time coding. The translated audio and text may be synchronized based on the time-coding and may be simultaneously transmitted to the portable computing device as depicted in FIG. 9.

The present invention may be particularly useful in public venues including musical and theatrical performances, sporting events, rallies, memorial services, religious ceremonies etc., where the live performance is being simultaneously displayed on a video screen. A very common issue associated with such public events is providing all attendees with the optimal sound quality and volume regardless of their proximity to the source of the sound. For example, a public speaker who uses a loudspeaker device to carry his voice to his audience will almost inevitably face the following problem: those who stand near the loudspeaker may be exposed to the sound at a high volume making the sound uncomfortable or even incomprehensible, while for those who stand further away may not be able to hear the speech due to dissipation of the sound as it travels away from the source. Furthermore, the speed of sound is much slower than the speed of light, and therefore, those who stand further away may perceive the sound to be out of sync with the visual content. Yet another important and frequently litigated issue is the disturbance of the surrounding neighborhoods due to the extremely loud sound of the live event.

The present invention effectively addresses the issues listed above. First, live sound may be transmitted at a lower volume, and the attendees may use the present invention to receive a clear high-quality audio stream right into their ears at their preferred volume. This resolves the issue of excessively loud sounds causing discomfort to some attendees and being a naissance for the surrounding areas, while ensuring that all attendees can hear the sound perfectly regardless of their position with respect to the source of the sound. Second, the invention can be configured to automatically detect the current weather conditions based on the geographical location of the portable computing device—such as temperature, humidity, pressure, and air density—and use this information to accurately estimate the time the live sound takes to travel through the air from the source to the user, and use this estimate to ensure that the streamed audio is synchronized with the live audio to avoid incongruences and lag.

Yet another application of the invention is for use by itself or in conjunction with an augmented reality device, such as GOOGLE GLASS, to deliver real time audio advertisement and other content. For example, as the user walks around a shopping mall the audio content from a particular store may be delivered to the user's handheld device when the device detects that a user's position corresponds to a predetermined location, such as a close proximity to the storefront. The streamed audio content is synchronized with a video display of the storefront, thus allowing the user to have a more fulfilling shopping experience, and providing the stores have an ability to deliver their audio content to interested users without having to broadcast the audio over the speakers.

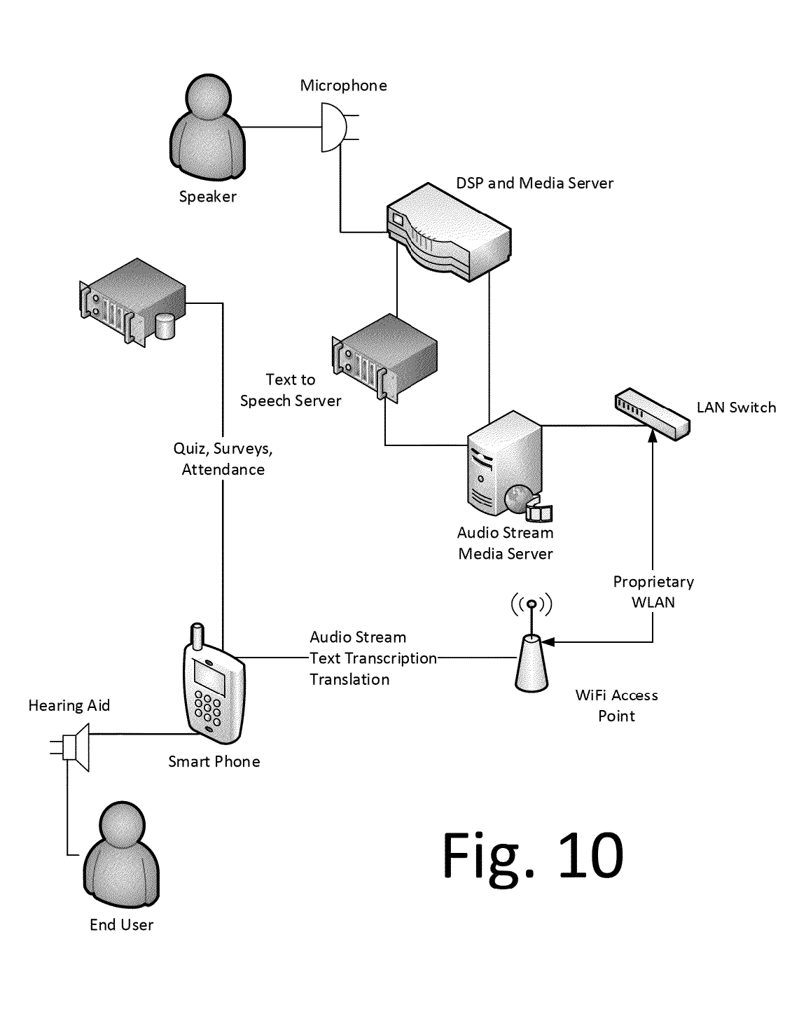

The present invention may also have utility for hearing-impaired and visually impaired individuals. For example, a hearing aid may be connected to the portable computing device—either by a wired connection or via a Bluetooth—so that the user may hear both the audio stream and any announcement transmitted by the facility, as shown in FIG. 10. Another way the invention may help those with hearing problems is as follows: the embodiment where the captioning is stored in an archive, the text may be transmitted to a handheld device so that the hearing-impaired user can read the captioning on the screen of his computing device. This feature provides several important benefits: 1) it is not necessary to display the closed captioning on the television screen where it may obstruct and interfere with the visual content, and 2) visually-impaired users will also benefit from having text in close proximity for easier reading. Furthermore, a refreshable Braille display may be connected to the portable computing device—such as one of the models produced by HUMANWARE—to allow for conversion of closed captioning to Braille. This feature would allow hearing impaired individuals who are also blind to receive streaming captioning at their fingertips.

In an embodiment, a dictionary of sign language indicia may be cached on the portable computing device. Each cached sign would be associated with corresponding word, allowing the textual closed captioning data to be translated into a series of animated hand signs. The user will be presented with an option to receive an animated sign language translation of the closed captioning directly on the display screen of the handheld computing device, thus providing further utility to the hearing-impaired individuals.

FIG. 10 provides a schematic of an embodiment that allows the system or an administrator to interrupt the audio stream to deliver scheduled or ad hoc announcements, warnings, advertisements, and other information. This feature may be very beneficial to the staff of the establishment implementing the audio-stream system because uninterrupted message can be delivered right into patrons' ears.

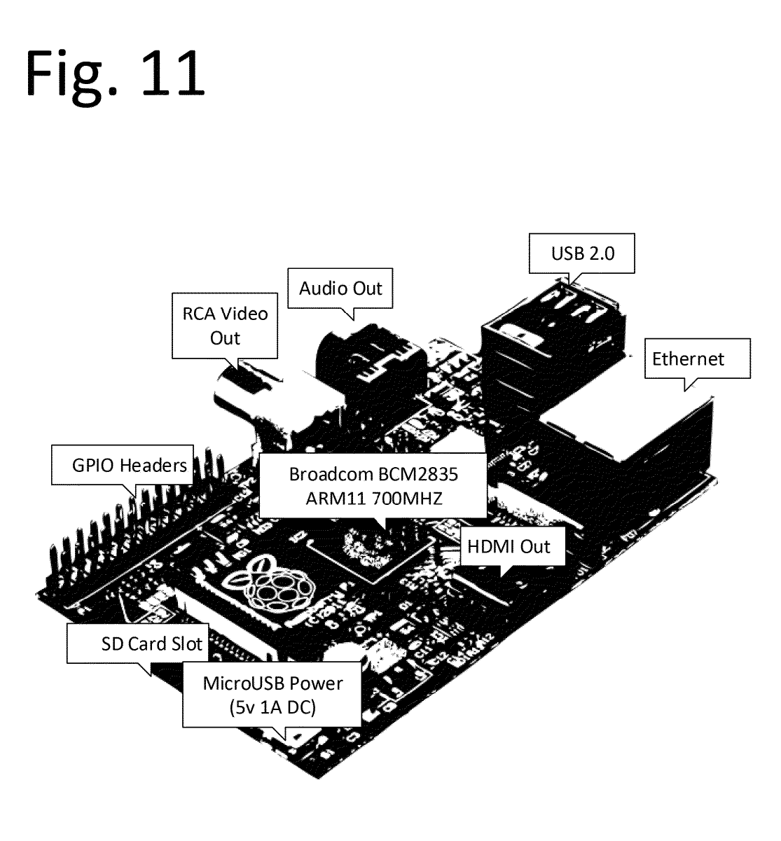

FIG. 11 shows a low-cost computing device sold under the brand RASPBERRY PI which features two USB 2.0 inputs into which audio may be accepted. As the USB 2.0 standard permits chaining device together, a plurality of audio inputs may be connected into an external hub which is then connected into the RASPBERRY PI device. An Ethernet connection provides networking connectivity and an HDMI out (or RCA video out) provides video display. The SD card slot stores non-volatile memory for the operating system and programs to enable the various embodiments of the invention.

Hardware and Software Infrastructure Examples

The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. An apparatus for transmitting audio to a portable computing device, the apparatus comprising:
a plurality of analog audio input feeds from a broadcast device selected from the group consisting of receivers, televisions, cable boxes and satellite boxes;
an analog-to-digital signal processor receiving the analog input feeds and converting the feeds to digital audio streams in real time;
an audio stream server providing access to the plurality of digital audio streams over a local wireless network; and
a portable computing device software application stored in non-transitory media providing a first set of instructions for a processor to play one of the plurality of digital audio streams on the portable computer device, and a second set of instructions for the processor to capture an SSID of a WiFi access point and to pass the SSID to a web server as a query string, whereby the web server associates the SSID with a corresponding facility and delivers facility-specific content to the portable computing device.

2. An apparatus for transmitting audio to a portable computing device, the apparatus comprising:
a data connection accessing a video on demand store having time-coded captioning in a first source language;
a translation engine server converting the time-coded captioning to a second destination language captioning;
a text-to-speech server converting the second destination language captioning to a time-coded audio file;
receiving broadcast audio in the first source language on a portable computing device;
automatically calculating the current time-code value of the broadcast audio in the first source language;
retrieving the time-coded audio file in the second destination language; and
synchronizing the broadcast of the second destination language audio file over the portable computing device with the broadcast audio in the first source language.

3. An apparatus for transmitting audio to a portable computing device, the apparatus comprising:
a line-in input for receiving a real time, analog audio feed;
a digital signal processor converting the analog audio feed to a digital audio stream;
an audio stream server providing access to the digital audio stream over a local wireless network; and
a portable computing device software application stored in non-transitory media providing instructions for a processor to receive the digital audio stream on the portable computer device and relay the stream to a wireless hearing aid receiver.
